(19) United States
(12) Patent Application Publication
(10) Pub. No.: US 2011/0019044 A1
(43) Pub. Date: Jan. 27, 2011

(54) Time Delay Integration Based MOS Photoelectric Pixel Sensing Circuit

(76) Inventors: Weng-Lyang Wang, Saratoga, CA (US); Shengmin Lin, Santa Clara, CA (US); Chi-Pin Lin, Kaohsiung (TW); Feng-Ke Hsiao, Nantou (TW)

Correspondence Address: CHEIN-HWA S. TSAO, 6684 MT PAKRON DRIVE, SAN JOSE, CA, 95120, US

(21) Appl. No.: 12/506,258

(22) Filed: Jul. 21, 2009

(51) Int. Cl. H04N 5/335

(52) U.S. Cl. 348/295; 348/E05.091

(57) ABSTRACT

A time delay integration (TDI) based MOS photoelectric pixel sensing circuit (TDIPSC) is proposed. The TDIPSC includes multi-element photoelectric pixel sensor (MEPS) having sub-pixel sensor elements SPSE₁, . . . , SPSE_{M} respectively converting a portion of pixel light into sub-pixel photoelectric signals (SPPES₁, . . . , SPPES_{M}). The TDIPSC also includes intermediate photoelectric signal accumulators (PESA₁, . . . , PESA_{M}) where any PESAₖ can be switchably coupled to any SPSEⱼ via switching transistors for receiving a corresponding SPPESⱼ from it and accruing an accumulated photoelectric signal ACPESₖ. A readout circuit (ROC) switchably coupled to any PESAₖ serves to remove and read the ACPESₖ. A TDI-sequence controller (TDISC) coupled to the SPSEs, the PESAs and the ROC executes a time sequence of cyclic coupling among them. The TDISC produces, via the ROC, a final time signal SQTS equal to the time delayed summation of the (SPPES₁, . . . , SPPES_{M}) with a reduced SNR.

### CROSS REFERENCE TO RELATED APPLICATION

This invention is related to the following previously filed US patent applications:
Title: “A Multi-resolution Image Sensor Array with High Image Quality Pixel Readout Circuitry” by Shengmin Lin, Weng-Lyang Wang, with U.S. patent application Ser. No. 11/869,732 and publication#US-2009-0091648 Attorney docket Number: CMOS003, hereinafter referred to as U.S. Ser. No. 11/869,732
Title: “Areal Active Pixel Image Sensor with Programmable Row-specific Gain for Hyper-Spectral Imaging”, Inventors: Weng-Lyang Wang, Shengmin Lin. U.S. application Ser. No. 12/171,351 Attorney docket Number: CMOS004, hereinafter referred to as U.S. Ser. No. 12/171,351
Title: “Wafer-scale Linear Image Sensor Chip and Method with Replicated Gapless Pixel Line and Signal Readout Circuit Segments”, Inventors: Weng-Lyang Wang, Shengmin Lin, Chi-Pin Lin, Feng-Ke Hsiao U.S. application Ser. No. 12/506,254 Attorney docket Number: CMOS012, hereinafter referred to as U.S. Ser. No. 12/506,254.
   whose contents are incorporated herein by reference for any and all purposes.

### BACKGROUND OF THE INVENTION

1. Field of the Invention

The present invention relates to electronic imaging. More particularly, the present invention is related to the system architecture and signal processing for a metal-oxide-semiconductor (MOS) based image sensor.

2. Related Background Art

In most electronic imaging devices for photoelectrically converting an incoming light image into an electrical output signal a very important, well known quality metric referencing their electrical output signal are their signal to Noise ratio (SNR)—a quantity desired to be as high as possible.

As an example known in the art to increase the sensitivity of an electronic imaging charge coupled device (CCD), a Time Delay Integration (TDI) CCD has been used to increase its SNR. In general, an N-tap TDI sensor employs N photoelectrical sensing elements with its final image signal output made equal to the summation, under a TDI timing scheme, of the individual outputs from the photoelectrical sensing elements. Referring to the output of an individual photoelectrical sensing element, as the final TDI image signal output is increased by N times whereas its noise content, being the summation of N separate thus uncorrelated individual photoelectrical sensing elements, is only increased by square-root-of-N times, the TDI CCD increases the SNR by square-root-of-N times.

While it is desirable to apply TDI to an MOS electronic imaging device for the same purpose, the structure of an MOS photoelectric sensing element, being typically a photodiode or a phototransistor, is quite different from a CCD cell thus requires a very different system architecture and signal processing to implement a TDI MOS image sensor and this is the primary object of the present invention.

### SUMMARY OF THE INVENTION

A TDI based MOS photoelectric pixel sensing circuit (TDIPSC) is proposed. The TDIPSC includes:
a) A multi-element photoelectric pixel sensor (MEPS) having numerous co-located yet mutually isolated photoelectric sub-pixel sensor elements SPSE₁, SPSE₂, . . . , SPSEⱼ, . . . , SPSE_{M} respectively converting and integrating a spatial portion of a pixel light impinging upon the MEPS into corresponding sub-pixel photoelectric signals (SPPES₁, SPPES₂, . . . , SPPESⱼ, . . . , SPPES_{M}).
b) Numerous intermediate photoelectric signal accumulators (PESA₁, PESA₂, . . . , PESAₖ, . . . , PESA_{M}). Any PESAₖ can be switchably coupled to any SPSEⱼ via a matrix of MOS switching transistors for receiving a corresponding SPPESⱼ from it and accruing an accumulated intermediate photoelectric signal (ACPESₖ). More specifically, the MOS switching transistors can be made of CMOS (complimentary metal-oxide-semiconductor) transistors.
c) A readout circuit (ROC) switchably coupled to any PESAₖ via numerous MOS switching transistors for removing and reading out a corresponding ACPESₖ from it.
d) A TDI-sequence controller (TDISC) coupled to the (SPSE₁, . . . , SPSE_{M}), the (PESA₁, . . . , PESA_{M}) and the ROC for effecting a pre-determined cyclic time sequence of coupling among them. As a result, the TDISC produces, via the ROC, final sequential time signals (SQTS) each equal to the time delayed summation of the (SPPES₁, . . . , SPPES_{M}) with a reduced SNR.

In a more specific embodiment, one cycle of the cyclic time sequence of coupling between the (SPSE₁, . . . , SPSE_{M}) and the (PESA₁, . . . , PESA_{M}) is as follows:
(SPSE₁-PESA₁, SPSE₂-PESA₂, . . . , SPSE_{M}-PESA_{M}).
(SPSE₁-PESA₂, SPSE₂-PESA₃, . . . , SPSE_{M}-PESA₁).
(SPSE₁-PESA_{M}, SPSE₂-PESA₁, . . . , SPSE_{M}-PESA_{M-1}).

In a more specific embodiment, one cycle of the cyclic time sequence of coupling between the (PESA₁, . . . , PESA_{M}) and the ROC is as follows:
(PESA₁-ROC).
(PESA₂-ROC).
(PESA_{M}-ROC).

In a more specific embodiment, each SPSEⱼ is a photo diode or a photo transistor.

In a more specific embodiment, each PESAₖ includes a resettable capacitive trans-impedance amplifier (CTIA) with a charge integration capacitor for resettably converting and accruing a SPPESⱼ into the ACPESₖ. Furthermore, the charge integration capacitance is selected to be large enough to minimize the image-degrading effect of inter-pixel differential leakage of the charge signal through the CTIA during an extended time period associated with the time delayed summation of the (SPPES₁, . . . , SPPES_{M}). Alternatively, each PESAₖ includes a switch-resettable unity gain amplifier (UGA) buffering the SPSEⱼ from the CTIA for converting the SPPESⱼ into a corresponding photoelectric voltage thus free from the image-degrading effect.

In a more detailed embodiment, each ROC includes a serial connection of an in-pixel correlated double sampling (CDS) circuit and an analog-to-digital converter (ADC) for extracting the desired ACPESₖ and digitizing it into a video output data.

These aspects of the present invention and their numerous embodiments are further made apparent, in the remainder of the present description, to those of ordinary skill in the art.

### BRIEF DESCRIPTION OF THE DRAWINGS

In order to more fully describe numerous embodiments of the present invention, reference is made to the accompanying drawings. However, these drawings are not to be considered limitations in the scope of the invention, but are merely illustrative:

FIG. 1 illustrates the overall circuit architecture of an example 4-tap TDI MOS photoelectric pixel sensing circuit TDIPSC of the present invention;

FIG. 2A through FIG. 2H illustrate an example of operational cyclic time sequence of coupling among the key components of the 4-tap TDIPSC of FIG. 1;

FIG. 3 illustrates the signal path under a first more detailed embodiment of the 4-tap TDIPSC of FIG. 1; and

FIG. 4 illustrates the signal path under a second more detailed embodiment of the 4-tap TDIPSC of FIG. 1.

### DETAILED DESCRIPTION OF THE PREFERRED EMBODIMENTS

The description above and below plus the drawings contained herein merely focus on one or more currently preferred embodiments of the present invention and also describe some exemplary optional features and/or alternative embodiments. The description and drawings are presented for the purpose of illustration and, as such, are not limitations of the present invention. Thus, those of ordinary skill in the art would readily recognize variations, modifications, and alternatives. Such variations, modifications and alternatives should be understood to be also within the scope of the present invention.

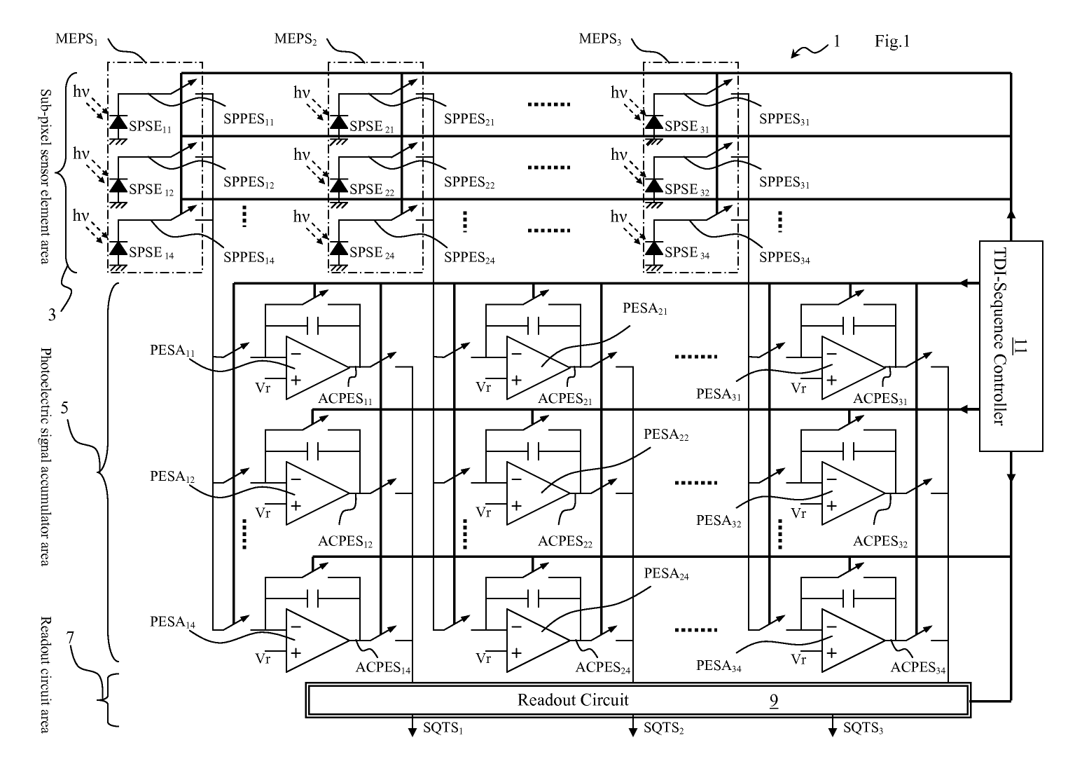

FIG. 1 illustrates the overall circuit architecture of an example 4-tap TDI MOS photoelectric pixel sensing circuit (TDIPSC) 1 of the present invention. The 4-tap TDIPSC 1 has, along the direction of photoelectric signal generation and processing, a sub-pixel sensor element area 3, a photoelectric signal accumulator area 5 and a readout circuit area 7. The sub-pixel sensor element area 3 has three multi-element photoelectric pixel sensors MEPS₁, MEPS₂ and MEPS₃. In turn, the MEPS₁ is composed of four (4) co-located yet mutually isolated photoelectric sub-pixel sensor elements (SPSE) SPSE₁₁, SPSE₁₂, SPSE₁₃ and SPSE₁₄. The MEPS₂ is composed of four (4) co-located yet mutually isolated photoelectric sub-pixel sensor elements SPSE₂₁, SPSE₂₂, SPSE₂₃ and SPSE₂₄, etc. In this case each SPSE is made of a photodiode although it can be a phototransistor as well. The SPSE₁₁, SPSE₁₂, SPSE₁₃, SPSE₁₄ respectively converts and integrates a spatial portion of a pixel light impinging upon MEPS₁ into corresponding sub-pixel photoelectric signals (SPPES) SPPES₁, SPPES₂, SPPES₃, SPPES₄.

For photoelectric signal processing relevant to the MEPS₁, four (4) intermediate photoelectric signal accumulators (PESA) PESA₁₁, PESA₁₂, PESA₁₃, PESA₁₄ are provided in the photoelectric signal accumulator area 5. In this case, each PESA includes a resettable capacitive trans-impedance amplifier (CTIA) with a charge integration capacitor for resettably converting and accruing an SPPES into an accumulated intermediate photoelectric signal (ACPES). As illustrated with a matrix of arrowed switches connected to the SPSEs, any of (PESA₁₁, PESA₁₂, PESA₁₃, PESA₁₄) can be switchably coupled to any of (SPPES₁₁, SPPES₁₂, SPPES₁₃, SPPES₁₄) via the matrix of switches for receiving a corresponding SPPES from it and accruing an ACPES, etc. For example, PESA₂₂ can be switchably coupled to SPPES₂₄ to accrue an ACPES₂₂, etc. The switches can be made of MOS switching transistors. More specifically, the switches can be made of CMOS (complimentary metal-oxide-semiconductor) transistors.

The readout circuit area 7 has a readout circuit (ROC) 9 switchably coupled to any PESA via a matrix of switches for removing and reading out a corresponding ACPES from it. The removal of ACPES can be done by resetting the CTIA after reading. The readout circuit 9 functions to produce, for each of MEPS₁, MEPS₂ and MEPS₃, final sequential photoelectric time signals (SQTS) SQTS₁, SQTS₂, SQTS₃. More details will be presently described for the readout circuit 9.

The 4-tap TDIPSC 1 also has a TDI-sequence controller (TDISC) 11 coupled to the matrix switches for the SPSEs, the matrix switches for the PESAs and the readout circuit 9 for effecting a pre-determined cyclic time sequence of coupling among them. As a result, the 4-tap TDIPSC 1 develops, via the readout circuit 9, a final sequential photoelectric time signal SQTS₁ for MEPS₁ equal to the time delayed summation of (SPPES₁₁, SPPES₁₂, SPPES₁₃, SPPES₁₄). Simultaneously, the 4-tap TDIPSC 1 also develops a final SQTS₂ for MEPS₂ equal to the time delayed summation of (SPPES₂₁, SPPES₂₂, SPPES₂₃, SPPES₂₄) and a final SQTS₃ for MEPS₃ equal to the time delayed summation of (SPPES₃₁, SPPES₃₂, SPPES₃₃, SPPES₃₄).

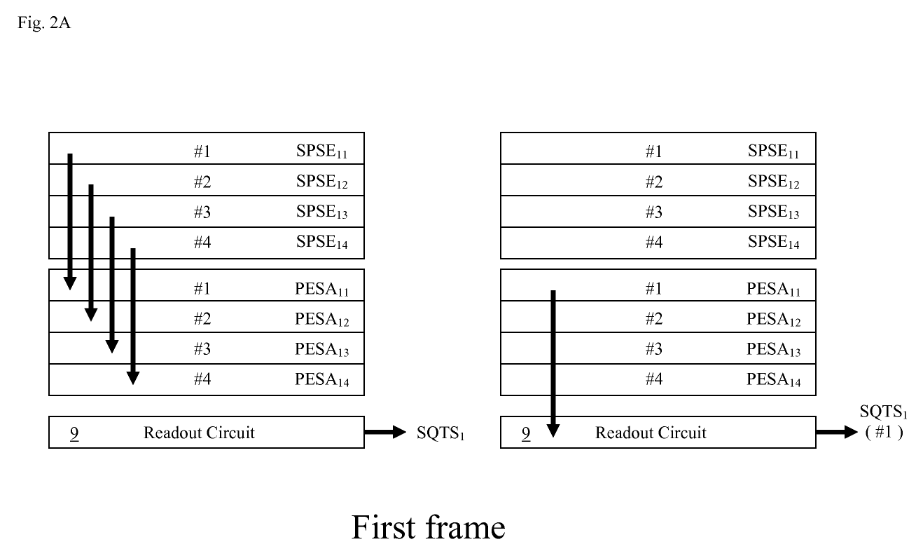

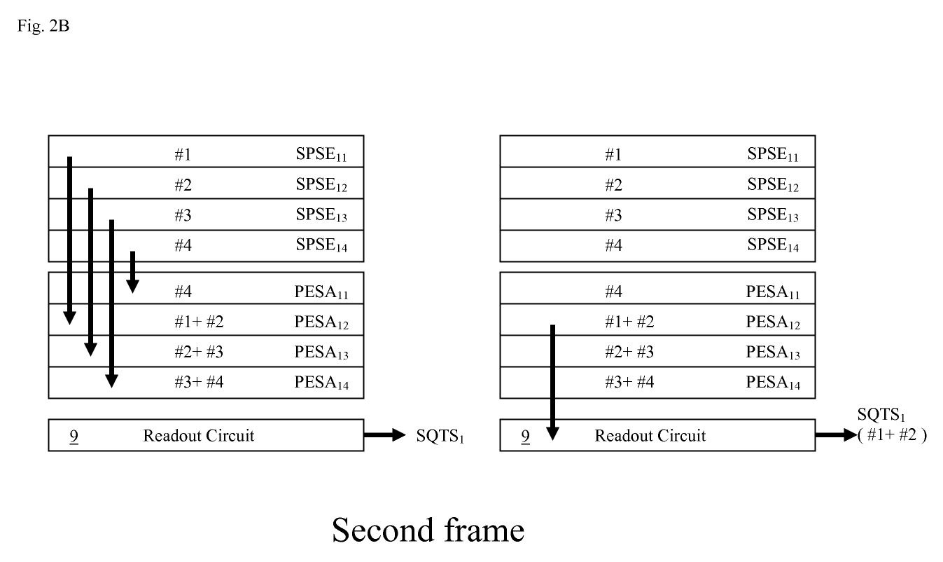

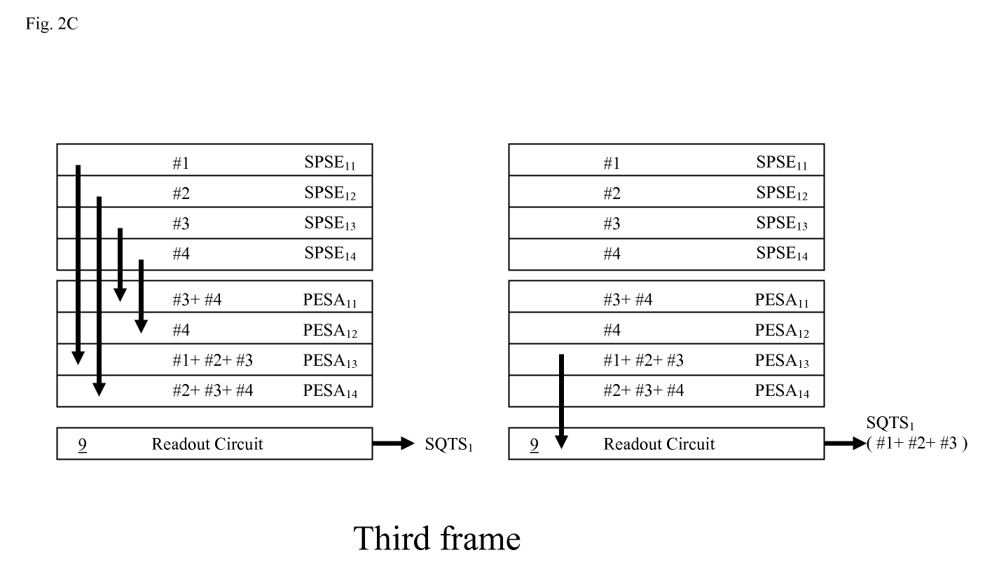

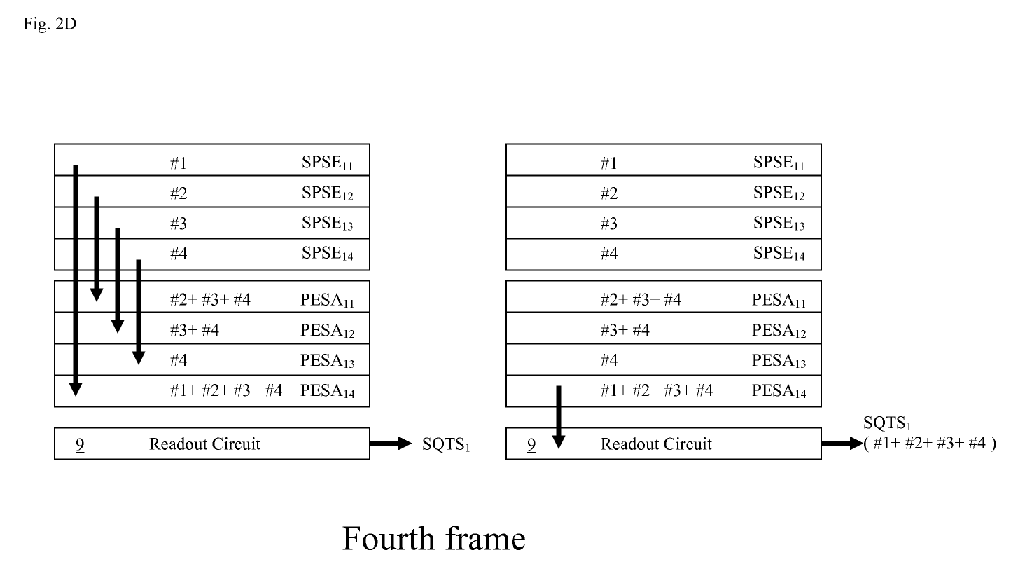

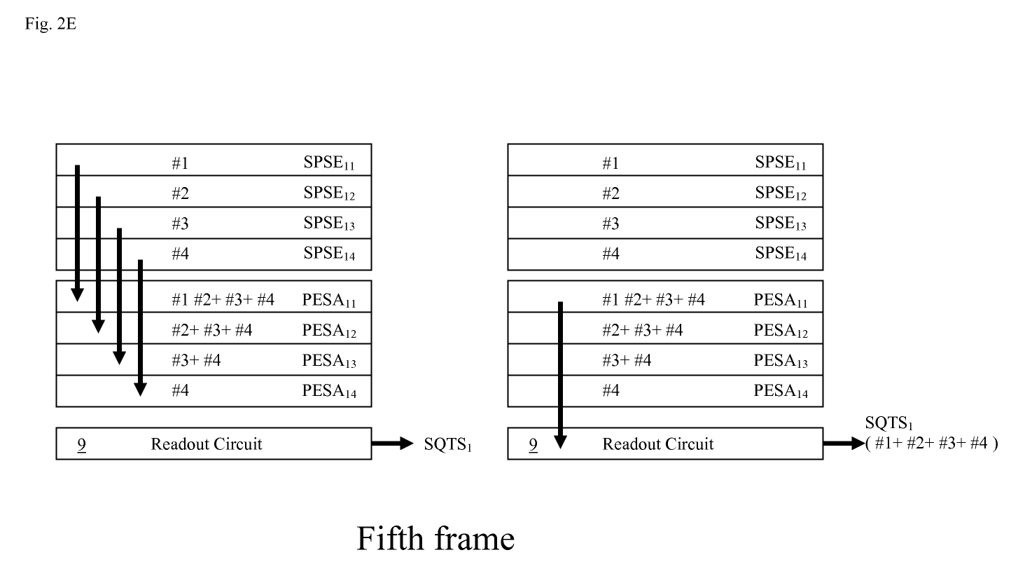

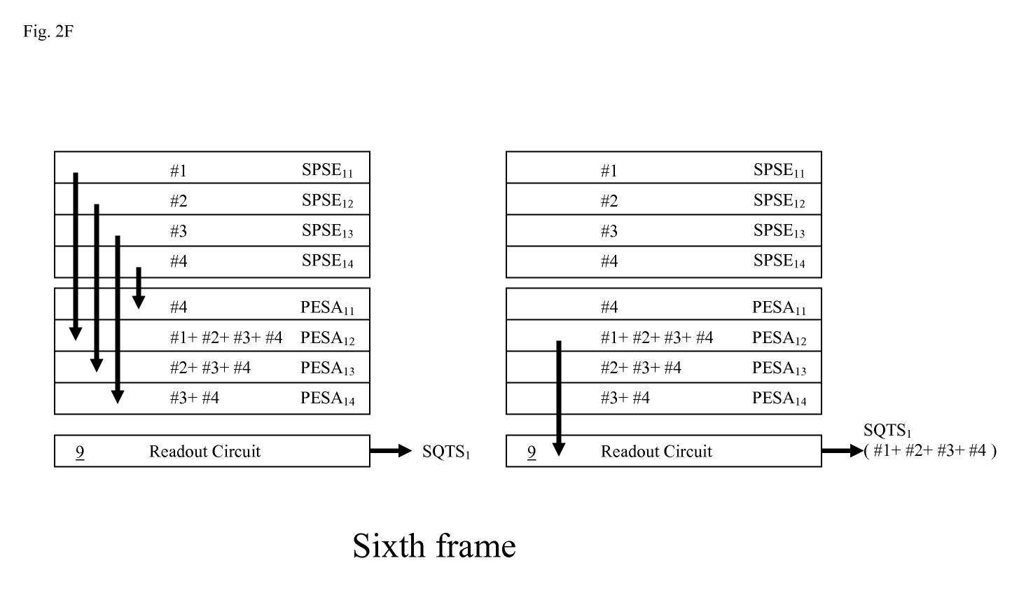

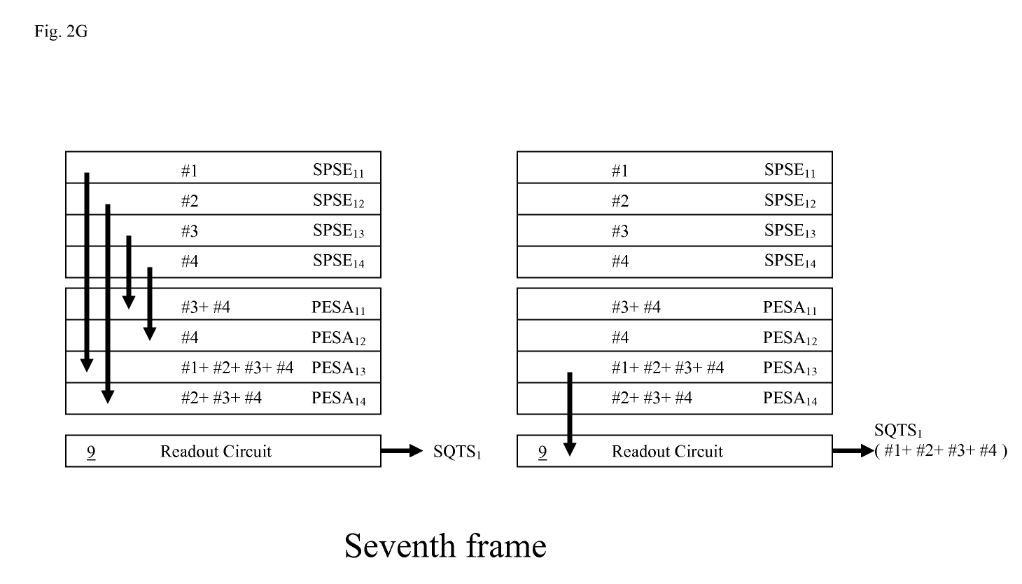

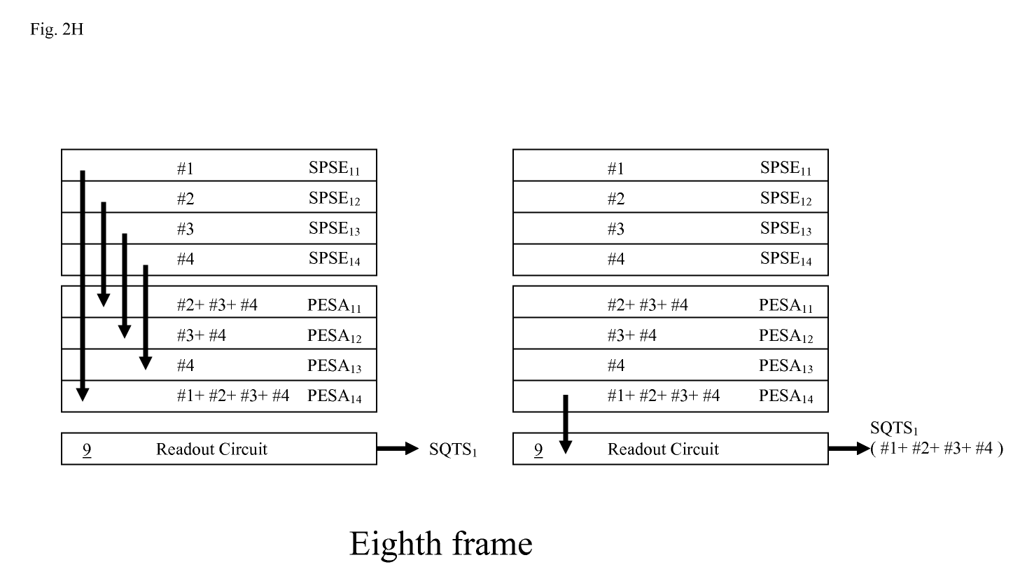

FIG. 2A through FIG. 2H, respectively named First frame through Eighth frame, illustrate an example of operational cyclic time sequence of coupling employed by the TDISC 11 of the 4-tap TDIPSC of FIG. 1. To simplify illustration, the following notations are adopted:
Sub-pixel photoelectric signal SPPES₁₁ on photoelectric sub-pixel sensor element SPSE₁₁ is labeled “#1”
SPPES₁₂ on SPSE₁₂ is labeled “#2”
SPPES₁₃ on SPSE₁₃ is labeled “#3”
SPPES₁₄ on SPSE₁₄ is labeled “#4”
Signal coupling between SPSE and PESA is symbolized by a down-arrow. For example, in the First frame, SPSE₁₄ is coupled to PESA₁₄. For another example, in the Third frame, SPSE₁₂ is coupled to PESA₁₄, etc.
Signal coupling and readout between PESA and readout circuit 9 is symbolized by a down-arrow. For example, in the Second frame, PESA₁₂ is coupled to and read by readout circuit 9. For another example, in the Seventh frame, PESA₁₃ is coupled to and read by readout circuit 9, etc.
   Tracing through the TDISC 11 operation from First frame to Eighth frame (FIG. 2A through FIG. 2H), the following sequence of SQTS₁ is generated:

| Frame number | SQTS₁ |
|---|---|
| First frame | #1 |
| Second frame | #1 + #2 |
| Third frame | #1 + #2 + #3 |
| Fourth frame | #1 + #2 + #3 + #4 |
| Fifth frame | #1 + #2 + #3 + #4 |
| Sixth frame | #1 + #2 + #3 + #4 |
| Seventh frame | #1 + #2 + #3 + #4 |
| Eighth frame | #1 + #2 + #3 + #4 |

It can be seen from the above that, except for an initial build up, the thus produced sequential photoelectric time signal SQTS₁ for MEPSⱼ at steady state is equal to the time delayed summation of (SPPES₁₁, SPPES₁₂, SPPES₁₃, SPPES₁₄). Similarly, to those skilled in the art, the thus produced sequential photoelectric time signal SQTS₂ for MEPS₂ at steady state is equal to the time delayed summation of (SPPES_{21,} SPPES₂₂, SPPES₂₃, SPPES₂₄), etc.

By now it should also become clear that the present invention is applicable to an N-tap TDI MOS photoelectric pixel sensing circuit (TDIPSC) where N can be any positive integer >1. The number of multi-element photoelectric pixel sensor MEPS can be any positive integer >=1. The spatial arrangement of the MEPS can be linear, a 2-dimensional array or any other arrangements targeting other applications.

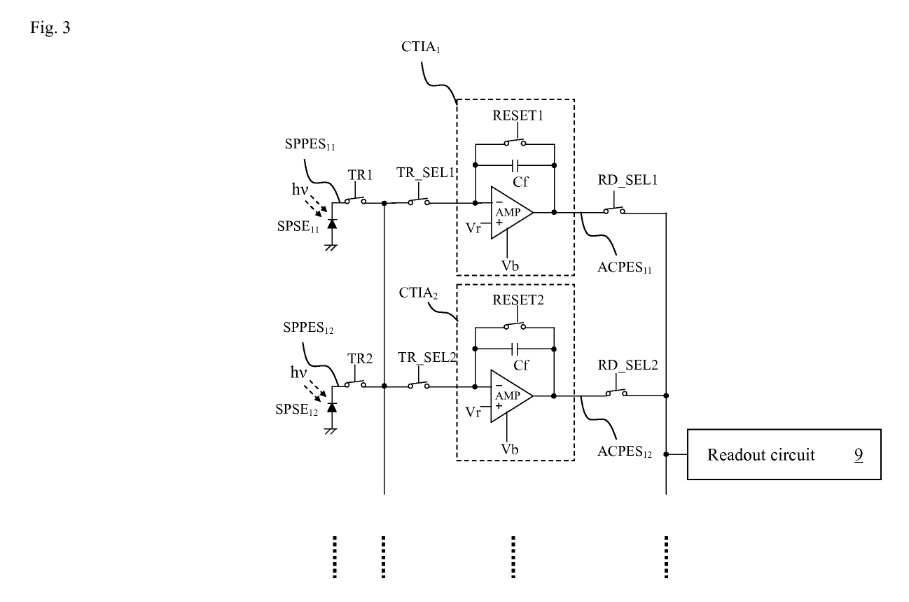

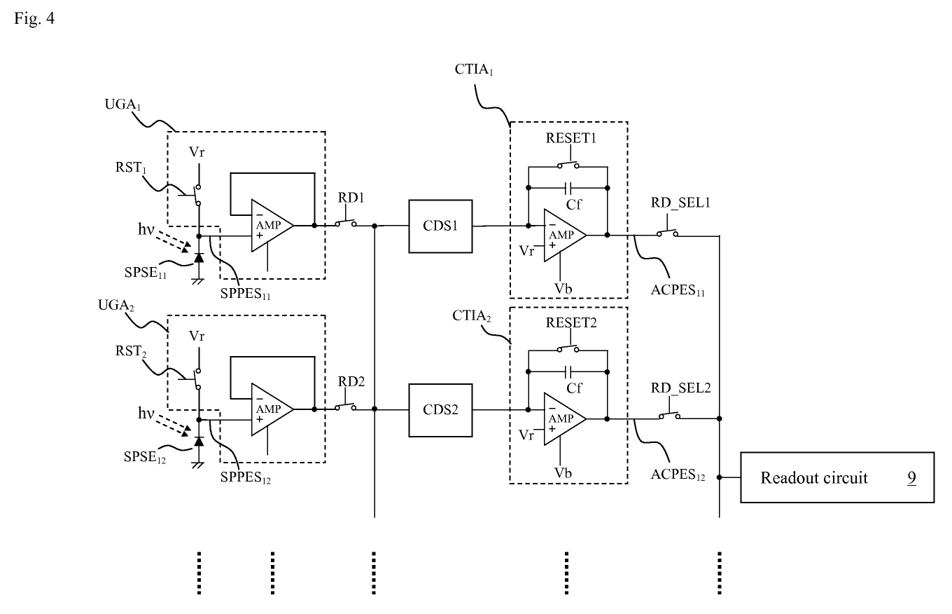

FIG. 3 illustrates the signal path from the SPSE to the readout circuit 9 under a first more detailed embodiment of the 4-tap TDIPSC of FIG. 1 where each PESA includes a resettable CTIA with a charge integration capacitor Cf. For example, coupling the SPSE₁₁ and the resettable CTIA1 are serially connected transfer control switch TR1 and transfer select switch TR_SEL1. Coupling the resettable CTIA1 and the readout circuit 9 is a read select switch RD_SEL1. The resettable CTIA1 can be reset (null out the signal ACPES₁₁) by closing the reset switch RESET1, etc. While not graphically illustrated here to avoid excessive obscuring details, the readout circuit 9 includes a serial connection of an in-pixel correlated double sampling (CDS) circuit and an analog-to-digital converter (ADC) for extracting the desired ACPES and digitizing it into a video output data. More related details have been illustrated in FIG. 1 and FIG. 4 of U.S. Ser. No. 12/171,351. Another remark here is that the charge integration capacitance Cf should be selected to be large enough to minimize the image-degrading effect of charge signal leakage through the CTIA during an extended time period associated with the time delayed summation of the (SPPES₁₁, SPPES₁₂, SPPES₁₃, SPPES₁₄) although a large Cf comes with the disadvantages of a large consumed circuit area and diminishing ACPES signal level.

As an alternative to avoid a large charge integration capacitance Cf, each PESA can include a switch-resettable unity gain amplifier (UGA) buffering the SPSE from the CTIA for converting the SPPES into a corresponding powered photoelectric voltage thus free from the aforementioned image-degrading effect of charge signal leakage and this is illustrated in FIG. 4. For example, a UGA1 now buffers the SPSE₁₁ from the resettable CTIA1. A serial connection of read switch RD1 and correlated double sampling circuit CDS1 is also inserted between the UGA1 and the resettable CTIA1 to subtract out a Reset kTC noise distortion generated with each reset of the UGA1, etc. More related details have been illustrated in FIG. 9 and FIG. 11 of U.S. Ser. No. 11/869,732.

With reference made to FIG. 1 of the present invention plus FIG. 2 of U.S. Ser. No. 12/506,254, yet another refinement of the present invention, when the sub-pixel sensor elements (SPSE₁₁, SPSE₁₂, SPSE₁₃, SPSE₁₄) are linearly placed along a sub-pixel sensor line, includes:
a) Placing the set of odd-numbered photoelectric signal accumulators (PESA₁₁, PESA₁₃) and the portion of readout circuit 9 connected to (PESA₁₁, PESA₁₃) along a first side of the sub-pixel sensor line.
b) Placing the set of even-numbered photoelectric signal accumulators (PESA₁₂, PESA₁₄) and the portion of readout circuit 9 connected to (PESA₁₂, PESA₁₄) along a second side of the sub-pixel sensor line.

In this way, when the linear spatial resolution of the sub-pixel sensor elements is limited by their associated signal accumulating and readout circuits, the achievable sub-pixel sensor resolution can be increased owing to the relief of an associated linear integration density of the signal accumulating and readout circuits.

A TDI based MOS photoelectric pixel sensing circuit (TDIPSC) is proposed for photoelectric image sensing with a reduced signal to noise ratio SNR. Throughout the description and drawings, numerous exemplary embodiments were given with reference to specific configurations. It will be appreciated by those of ordinary skill in the art that the present invention can be embodied in numerous other specific forms and those of ordinary skill in the art would be able to practice such other embodiments without undue experimentation. The scope of the present invention, for the purpose of the present patent document, is hence not limited merely to the specific exemplary embodiments of the foregoing description, but rather is indicated by the following claims. Any and all modifications that come within the meaning and range of equivalents within the claims are intended to be considered as being embraced within the spirit and scope of the present invention.

What is claimed is:

1. A time delay integration (TDI) based MOS photoelectric pixel sensing circuit (TDIPSC) comprising:
a) a multi-element photoelectric pixel sensor (MEPS) further comprising a plurality of co-located yet mutually isolated photoelectric sub-pixel sensor elements (SPSE₁, SPSE₂, . . . , SPSEⱼ, . . . , SPSE_{M} where M>1) respectively converting and integrating a spatial portion of a pixel light impinging upon the MEPS into corresponding sub-pixel photoelectric signals (SPPES₁, SPPES₂, . . . , SPPESⱼ, . . . , SPPES_{M});
b) a plurality of intermediate photoelectric signal accumulators (PESA₁, PESA₂, . . . , PESAₖ, . . . , PESA_{M}) wherein any PESAₖ can be switchably coupled to any SPSEⱼ for receiving a corresponding SPPESⱼ there from and accruing an accumulated intermediate photoelectric signal (ACPESₖ);
c) a readout circuit (ROC) switchably coupled to any PESAₖ for removing and reading out a corresponding ACPESₖ there from; and
d) a TDI-sequence controller (TDISC) coupled to the (SPSE₁, . . . , SPSE_{M}), the (PESA₁, . . . , PESA_{M}) and the ROC for effecting a pre-determined cyclic time sequence of coupling amongst them
whereby produce, via the ROC, final sequential time signals (SQTS) each equal to the time delayed summation of the (SPPES₁, . . . , SPPES_{M}) with a reduced signal-to-noise ratio (S/N).

2. The TDIPSC of claim 1 wherein one cycle of the cyclic time sequence of coupling between the (SPSE₁, . . . , SPSE_{M}) and the (PESA₁, . . . , PESA_{M}) is:
(SPSE₁-PESA₁, SPSE₂-PESA₂, . . . , SPSE_{M}-PESA_{M});
(SPSE₁-PESA₂, SPSE₂-PESA₃, . . . , SPSE_{M}-PESA₁);
. . . ; and
(SPSE₁-PESA_{M}, SPSE₂-PESA₁, . . . , SPSE_{M}-PESA_{M-1}).

3. The TDIPSC of claim 1 wherein one cycle of the cyclic time sequence of coupling between the (PESA₁, . . . , PESA_{M}) and the ROC is:
(PESA₁-ROC);
(PESA₂-ROC);
. . . ; and
(PESA_{M}-ROC).

4. The TDIPSC of claim 1 wherein each SPSE1 is a photo diode or a photo transistor.

5. The TDIPSC of claim 1 wherein each PESAₖ comprises a resettable capacitive trans-impedance amplifier (CTIA) with a charge integration capacitor for resettably converting and accruing, through time integration, a SPPESⱼ into the ACPESₖ and, the charge integration capacitance is selected to be large enough to minimize the image-degrading effect of inter-pixel differential leakage of the charge signal through the CTIA during an extended time period associated with the time delayed summation of the (SPPES₁, . . . , SPPES_{M}).

6. The TDIPSC of claim 5 wherein each PESAₖ further comprises a switch-resettable unity gain amplifier (UGA) buffering the SPSEⱼ from the CTIA for converting the SPPESⱼ into a corresponding photoelectric voltage thus free from said image-degrading effect.

7. The TDIPSC of claim 1 wherein each ROC further comprises a serial connection of an in-pixel correlated double sampling (CDS) circuit and an analog-to-digital converter (ADC) for extracting the desired ACPESₖ and digitizing it into a video output data.

8. The TDIPSC of claim 1 wherein said sub-pixel sensor elements (SPSE₁, SPSE₂, . . . , SPSEⱼ, SPSE_{M}) are placed along a sub-pixel sensor line and:
a) the set of odd-numbered photoelectric signal accumulators (PESA₁, PESA₃, PESA₅, . . . ) and the portion of ROC connected thereto are placed along a first side of the sub-pixel sensor line; and
b) the set of even-numbered photoelectric signal accumulators (PESA₂, PESA₄, PESA₆, . . . ) and the portion of ROC connected thereto are placed along a second side of the sub-pixel sensor line
whereby increase the achievable linear spatial resolution of the sub-pixel sensor elements when the resolution is limited by their signal accumulating and readout circuits.

9. The TDIPSC of claim 1 further comprises a matrix of MOS (metal-oxide-semiconductor) switching transistors for switchably coupling said any PESAₖ to said any SPSEⱼ.

10. The TDIPSC of claim 9 wherein said matrix of MOS switching transistors further comprises a matrix of CMOS (complimentary metal-oxide-semiconductor) transistors.

11. The TDIPSC of claim 1 further comprises a plurality of MOS switching transistors for switchably coupling said ROC to said any PESAₖ.

12. The TDIPSC of claim 11 wherein said plurality of MOS switching transistors further comprises a plurality of CMOS transistors.
